(19) United States
(12) Patent Application Publication
(10) Pub. No.: US 2012/0242725 A1
(43) Pub. Date: Sep. 27, 2012

(54) LIQUID EJECTING APPARATUS

(75) Inventor: Noboru TAMURA, Matsumoto-shi (JP)

(73) Assignee: SEIKO EPSON CORPORATION, Tokyo (JP)

(21) Appl. No.: 13/429,305

(22) Filed: Mar. 23, 2012

(30) Foreign Application Priority Data
Mar. 24, 2011 (JP) 2011-065391

(51) Int. Cl. B41J 29/38

(52) U.S. Cl. 347/9

(57) ABSTRACT

A liquid ejecting apparatus includes: a carriage that moves in an orthogonal direction that is orthogonal to a transport direction in which a medium is transported; and a head unit, provided in the carriage, that includes a nozzle, a driving element that causes a liquid to be ejected through the nozzle, a head control unit that controls the driving of the driving element by selectively applying a driving signal to the driving element, and a head case that has a part formed of a metal member and that houses the head control unit within the case in a state in which the head control unit makes contact with the metal member.

This application claims priority to Japanese Patent Application No. 2011-065391 filed on Mar. 24, 2011.

### BACKGROUND

1. Technical Field

The present invention relates to liquid ejecting apparatuses.

2. Related Art

An ink jet printer that prints by ejecting ink onto a medium such as paper is known as an example of a liquid ejecting apparatus. The ink jet printer is provided with a head unit, and the head unit includes nozzles, driving elements (for example, piezoelectric elements) that correspond to the nozzles, and a head control circuit that selectively applies driving signals to the driving elements (for example, see JP-A-11-300956).

In this type of ink jet printer, the head control circuit produces heat due to the current that flows when the driving signals are applied to the driving elements; if the temperature rises excessively due to the heat produced by the head control circuit, erroneous operations or malfunctions can occur.

### SUMMARY

It is an advantage of some aspects of the invention to improve a heat dissipation effect by efficiently dissipating heat that has been produced by a head control circuit.

The descriptions in this specification and the appended drawings will make clear at least the following points.

According to an aspect of the invention, a liquid ejecting apparatus includes: a carriage that moves in an orthogonal direction that is orthogonal to a transport direction in which a medium is transported; and a head unit, provided in the carriage, that includes a nozzle, a driving element that causes a liquid to be ejected through the nozzle, a head control unit that controls the driving of the driving element by selectively applying a driving signal to the driving element, and a head case that has a part formed of a metal member and that houses the head control unit within the case in a state in which the head control unit makes contact with the metal member.

According to this liquid ejecting apparatus, part of the head case is formed of the metal member, and the head control unit is housed within the case in a state in which the head control unit makes contact with the metal member; accordingly, the head dissipation effects can be improved, and erroneous operations of the head control unit can be suppressed.

Furthermore, in the liquid ejecting apparatus, it is preferable that the part formed of the metal member be grounded.

According to this liquid ejecting apparatus, it is possible to suppress the head control unit from being damaged by static electricity, suppress problems such as erroneous operations caused by the static electricity overlapping with the driving signals as noise, and so on.

Furthermore, in the liquid ejecting apparatus, it is preferable that the carriage move in the orthogonal direction along a guide rail; the head case have a first side surface portion that is downstream from the guide rail in the transport direction and a second side surface portion that is downstream from the first side surface portion in the transport direction; and the part formed of the metal member be provided on an area of the head case that is toward the second side surface portion.

According to this liquid ejecting apparatus, it is easier for the part formed of the metal member to come into contact with the air outside of the printer that is cooler than the air inside of the printer, which makes it possible to further improve the heat dissipation effects.

Furthermore, in the liquid ejecting apparatus, it is preferable that the carriage have an opening in its bottom surface; the head case be supported by the carriage in a state in which the part formed of the metal member is exposed from the opening; and the part formed of the metal member be cooled as a result of the carriage moving in the orthogonal direction.

According to this liquid ejecting apparatus, because the metal member makes contact with air as the carriage moves, the heat dissipation effects can be further improved.

Furthermore, in the liquid ejecting apparatus, it is preferable that the part formed of the metal member have a plurality of fins.

According to this liquid ejecting apparatus, the surface area that makes contact with the outside air can be increased; this increases the amount of heat that is dissipated from the metal member into the air, which further improves the heat dissipation effects.

Furthermore, in the liquid ejecting apparatus, it is preferable that the part formed of the metal member form an air cavity portion that follows the orthogonal direction; the air cavity portion may have ventilation ports on one side and the other side in the orthogonal direction; and the ventilation ports may be formed so that the sizes of the ventilation ports are greater than the cross-sectional size of the air cavity portion that is located between the ventilation ports.

According to this liquid ejecting apparatus, the amount of air pulled into the air cavity portion through the ventilation ports can be increased, which makes it possible to further improve the heat dissipation effects.

### BRIEF DESCRIPTION OF THE DRAWINGS

The invention will be described with reference to the accompanying drawings, wherein like numbers reference like elements.

FIG. 1 is a block diagram illustrating the overall configuration of a printer.

FIGS. 2A and 2B are general diagrams illustrating the configuration of the printer; FIG. 2A is a perspective view illustrating the printer, whereas FIG. 2B is a cross-sectional view of the printer seen from the side.

FIG. 3 is a block diagram illustrating a head control unit.

FIG. 4 is a descriptive diagram illustrating the timings of various signals.

FIG. 5 is an exploded perspective view illustrating the periphery of the head control unit.

FIG. 6 is a general diagram illustrating a head unit that is mounted in a carriage.

FIG. 7 is a general diagram illustrating a different example of a configuration of a head case.

FIG. 8 is a general diagram illustrating a different example of a configuration of a head case.

FIG. 9 is a plan view illustrating the configuration of an air cavity portion.

### DESCRIPTION OF EXEMPLARY EMBODIMENTS

The following describes an embodiment using an ink jet printer 1 (also called a “printer 1” hereinafter) as an example.

### Embodiment

### Example of Configuration of Printer 1

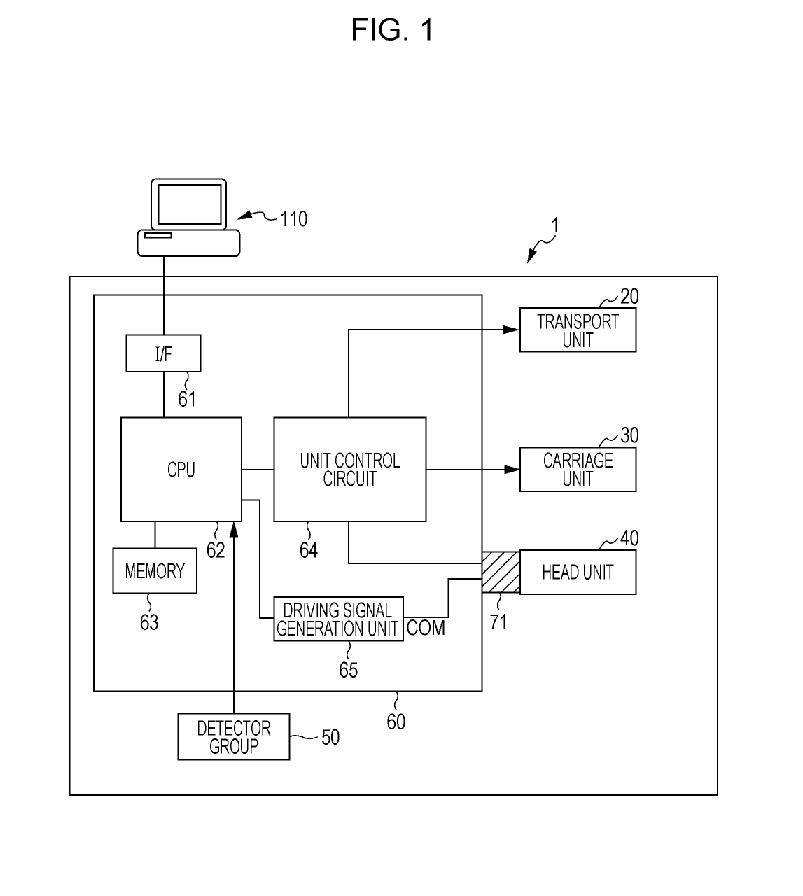

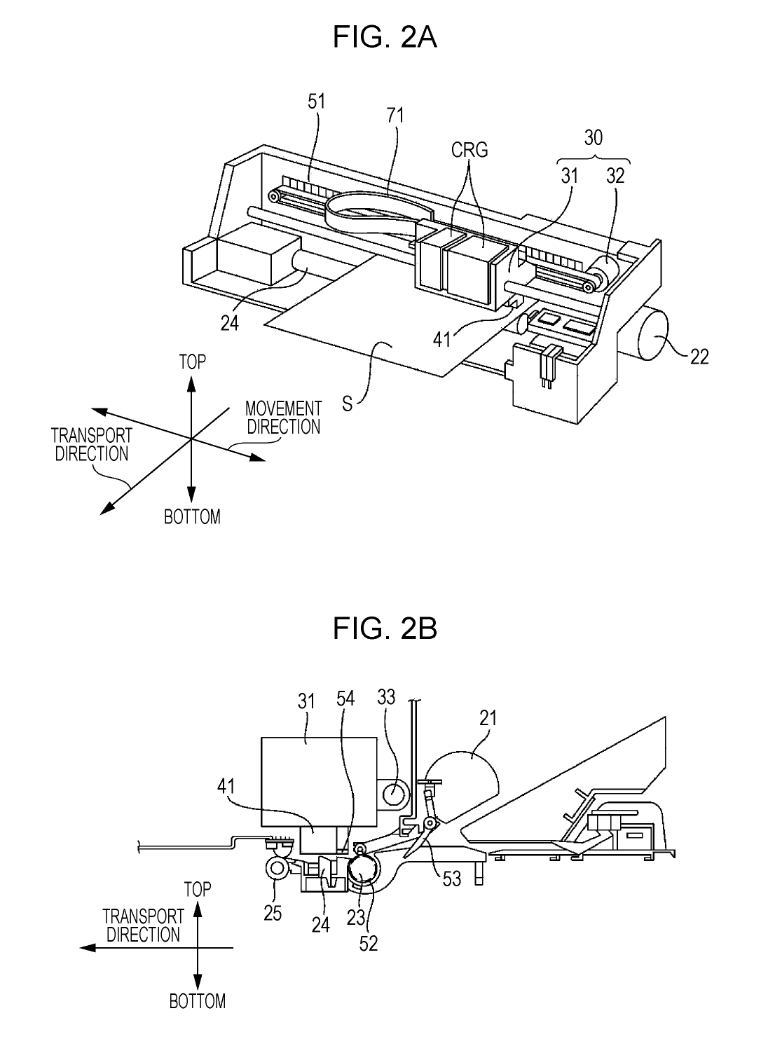

An example of the configuration of the printer 1 will be described using FIGS. 1 through 2B. FIG. 1 is a block diagram illustrating the overall configuration of the printer 1 according to this embodiment. FIG. 2A is a perspective view of the printer 1, whereas FIG. 2B is a cross-sectional view of the printer 1 seen from the side.

The printer 1 according to this embodiment includes: a transport unit 20 serving as an example of a transport unit; a carriage unit 30; a head unit 40 serving as an example of a head unit; a detector group 50; and a controller 60. Having received print data from a computer 110, which is an external device, the printer 1 controls the various units (the transport unit 20, the carriage unit 30, and the head unit 40) using the controller 60. The controller 60 prints an image onto paper by controlling the various units based on the print data received from the computer 110. The internal state of the printer 1 is monitored by the detector group 50, and the detector group outputs detection results to the controller 60. The controller 60 controls the various units based on the detection results outputted by the detector group 50.

The transport unit 20 is a unit for transporting a medium S (for example, paper S or the like) in a predetermined direction (called the “transport direction” hereinafter). This transport unit 20 includes a paper feed roller 21, a transport motor 22 (also called a “PF motor”), a transport roller 23, a platen 24, and a paper discharge roller 25. The paper feed roller 21 is a roller for feeding paper that has been inserted into a paper insertion opening into the printer. The transport roller 23 is a roller that transports the paper S supplied by the paper feed roller 21 to a region where printing can be carried out, and is driven by the transport motor 22. The platen 24 supports the paper S during printing. The paper discharge roller 25 is a roller that discharges the paper S to the exterior of the printer, and is provided downstream, in the transport direction, from the region where printing can be carried out.

The carriage unit 30 is a unit for causing a head to move (also called “scanning”) in an orthogonal direction (called a “movement direction” hereinafter) that is orthogonal to the transport direction. The carriage unit 30 includes a carriage 31 and a carriage motor 32 (also called a “CR motor”). The carriage 31 is capable of moving back and forth in the movement direction along a guide rail 33, and is driven by the carriage motor 32. The carriage 31 also holds a detachable ink cartridge CRG that contains ink.

The head unit 40 is a unit for ejecting ink onto paper. The head unit 40 includes a head 41 having a plurality of nozzles, a head control unit HC (head control circuit), and a head case 45 that houses these elements. The head 41 is provided in the carriage 31, and thus when the carriage 31 moves in the movement direction, the head 41 also moves in the movement direction. A dot line (raster line) is formed on the paper along the movement direction by the head 41 intermittently ejecting ink while moving in the movement direction. Note the details of the configuration of the head 41 and details of the head control unit HC will be given later.

The detector group 50 includes a linear encoder 51, a rotary encoder 52, a paper detection sensor 53, an optical sensor 54, and so on. The linear encoder 51 detects the position of the carriage 31 in the movement direction. The rotary encoder 52 detects the rotation amount of the transport roller 23. The paper detection sensor 53 detects the position of the leading edge of the paper S that is currently being fed. The optical sensor 54 detects the presence/absence of the paper S using a light-emitting portion and a light-receiving portion attached to the carriage 31. The optical sensor 54 can also detect the positions of the ends of the paper S while being moved by the carriage 31, and can thus detect the width of the paper S. In addition, the optical sensor 54 is, depending on the circumstances, capable of detecting the leading edge (the edge on the downstream side in the transport direction; also called the “top end”) and the following edge (the edge on the upstream side in the transport direction; also called the “bottom end”) of the paper S.

The controller 60 is a control unit for controlling the printer 1. The controller 60 includes an interface unit 61, a CPU 62, a memory 63, a unit control circuit 64, and a driving signal generation unit 65. The interface unit 61 serves to exchange data between the computer 110, which is an external device, and the printer 1. The CPU 62 is a computational processing device for carrying out overall control of the printer. The memory 63 is a unit for securing a region for holding programs for the CPU 62, a work region, or the like, and has a storage device such as a RAM or the like. The CPU 62 controls the respective units via the unit control circuit 64, in accordance with a program held in the memory 63.

The driving signal generation unit 65 generates a common driving signal COM. The common driving signal COM generated by the driving signal generation unit 65 is transmitted to the head (that is, the head unit 40) from the main unit (that is, the controller 60) from the through a flexible cable 71.

### Head Unit 40

### Head Control Unit HC

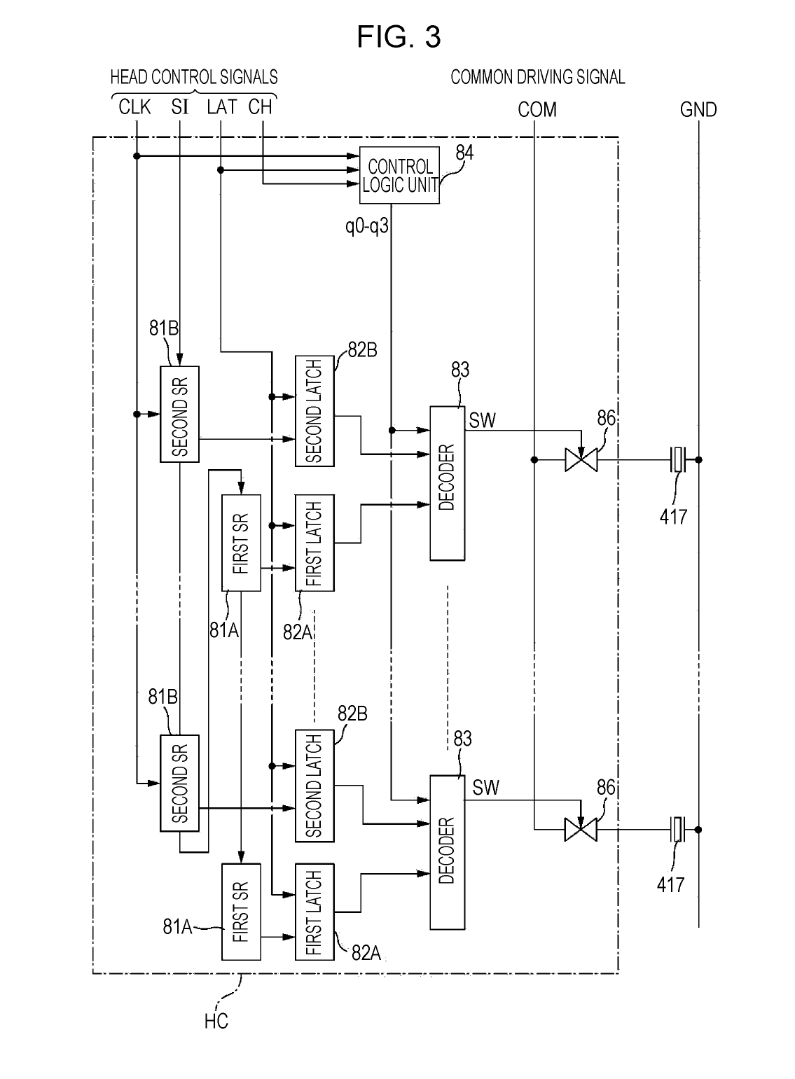

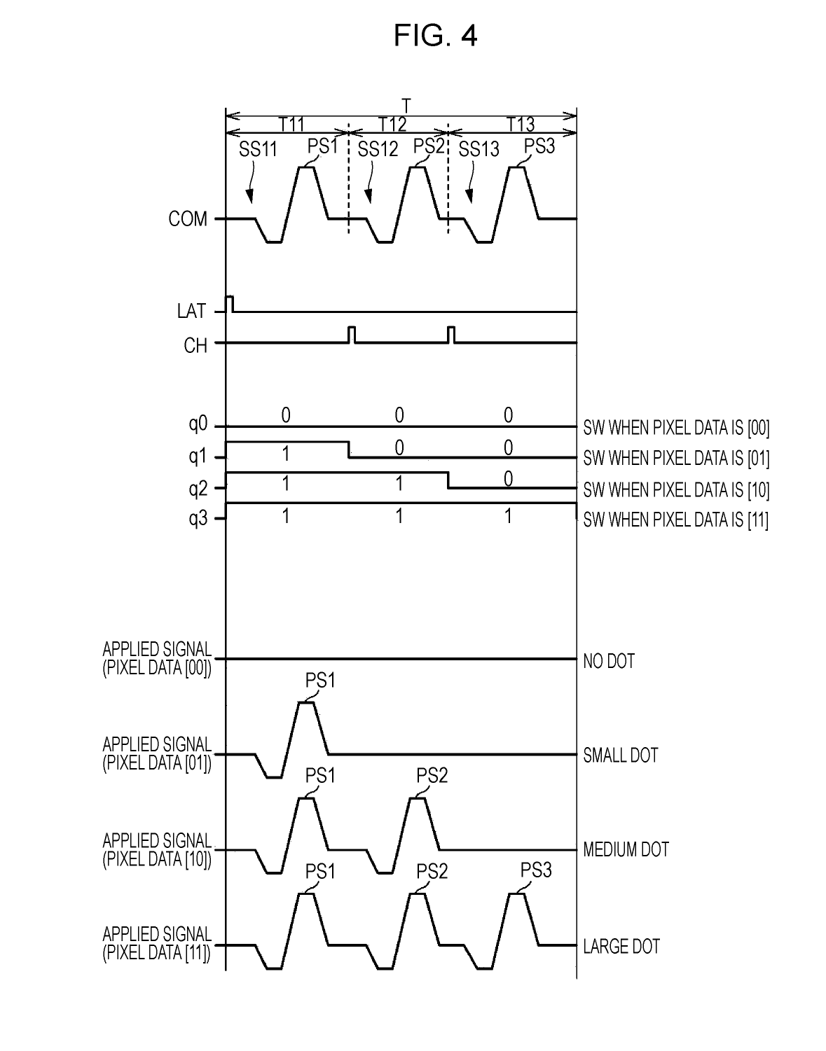

Here, the head control unit HC will be described using FIGS. 3 and 4. FIG. 3 is a block diagram illustrating the head control unit HC, whereas FIG. 4 is a descriptive diagram illustrating the timings of various signals.

The head control unit HC includes a first shift register 81A, a second shift register 81B, a first latch circuit 82A, a second latch circuit 82B, a decoder 83, a control logic unit 84, and a switch 86. Each of the elements aside from the control logic unit 84 (that is, the first shift register 81A, the second shift register 81B, the first latch circuit 82A, the second latch circuit 82B, the decoder 83, and the switch 86) is provided for each of piezoelectric elements 417. Note that the piezoelectric elements 417 are elements that are driven in order to eject ink from nozzles (that is, driving elements), and are provided for each nozzle in the head 41.

The common driving signal COM, a latch signal LAT, a change signal CH, pixel data SI, and a clock signal CLK are inputted into the head control unit HC. These signals will be described hereinafter.

The driving signal COM is generated every repeated cycle T. The repeated cycle T is the amount of time required for the carriage 31 to move a predetermined distance. In this manner, the same waveform COM is generated by the driving signal generation unit 65 each time the carriage 31 moves the predetermined distance. The common driving signal COM includes a first waveform section SS11 generated in an interval T11 of the repeated cycle T, a second waveform section SS12 generated in an interval T12 of the repeated cycle T, and a third waveform section SS13 generated in an interval T13 of the repeated cycle T. Here, the first waveform section SS11 has a driving pulse PS1. Likewise, the second waveform section SS12 has a driving pulse PS2, and the third waveform section SS13 has a driving pulse PS3. The driving pulse PS1, the driving pulse PS2, and the driving pulse PS3 are applied to the piezoelectric elements 417 when forming large dots, as will be described in detail later, and have the same waveforms as each other. Meanwhile, the driving pulse PS1 and the driving pulse PS2 are also applied to the piezoelectric elements 417 when forming medium dots, as will be described in detail later. Finally, the driving pulse PS1 is also applied to the piezoelectric elements 417 when forming small dots, as will be described in detail later. Note that when a driving pulse is not applied to the piezoelectric elements 417, ink is not ejected (that is, a dot is not formed).

The driving signal COM is inputted into each switch 86 provided for each of the piezoelectric elements 417. The switches 86 switch on/off to control whether or not the driving signal COM is inputted into the corresponding piezoelectric element 417. Through this on/off control, parts of the driving signal COM can be applied selectively to the piezoelectric elements 417, which makes it possible to change the size of the dots. In this manner, each waveform section corresponds to a single unit applied to the piezoelectric elements 417. Note that the control for applying the respective waveform sections to the piezoelectric elements 417 will be described in detail later.

The latch signal LAT is a signal expressing the repeated cycle T (the interval in which the head 41 moves a segment equivalent to one pixel). In other words, the latch signal LAT is generated by the controller 60 based on a signal from the linear encoder 51 outputted each time the carriage 31 moves the predetermined distance, and is inputted into the control logic unit 84 and the latch circuits (the first latch circuits 82A and the second latch circuits 82B).

The change signal CH is a signal expressing an interval that is one third the repeated cycle T. The change signal CH is generated by the controller 60 based on a signal from the linear encoder 51, and is inputted into the control logic unit 84.

The pixel data SI is a signal expressing a gradation for each pixel (that is, no dot, a small dot, a medium dot, or a large dot). This pixel data is generated as two bits for every single nozzle. For example, in the case where there are 64 nozzles, 64 pieces of two-bit pixel data SI are sent from the controller 60 every repeated cycle T. Note that the pixel data SI is inputted into the first shift registers 81A and the second shift registers 81B.

The clock signal CLK is a signal used when setting the pixel data SI sent from the controller 60 in the respective shift registers (the first shift registers 81A and the second shift registers 81B).

Next, signals generated by the head control unit HC will be described. The head control unit HC generates selection signals q0 through q3, switch control signals SW, and application signals.

The selection signals q0 through q3 are generated by the control logic unit 84 based on the latch signal LAT and the change signal CH. The generated selection signals q0 through q3 are inputted into each decoder 83 provided for the piezoelectric elements 417.

The switch control signals SW are selected by the decoder 83 through one of the selection signals q0 through q3 based on the pixel data (two bits) latched by the respective latch circuits (the first latch circuits 82A and the second latch circuits 82B). The switch control signals SW generated by the respective decoders 83 are inputted into the corresponding switches 86.

The application signals are outputted from the switches 86 based on the common driving signal COM and the switch control signal. This application signals are applied to the piezoelectric elements 417 corresponding to the respective switches 86.

### Operations of Head Control Unit HC

The head control unit HC carries out control for ejecting ink based on the pixel data SI from the controller 60. In other words, the head control unit HC controls the switches 86 to turn on/off based on the print data, and causes the necessary waveform sections of the common driving signal COM to be applied selectively to the piezoelectric elements 417. To rephrase, the head control unit HC controls the driving of the piezoelectric elements 417. In this embodiment, the pixel data SI is configured of two bits. The pixel data SI is sent to the head 41 in synchronization with the clock signal CLK. A group of the most significant bits of the pixel data SI is set in the respective first shift registers 81A, whereas a group of the least significant bits is set in the respective second shift registers 81B. The first latch circuits 82A are electrically connected to corresponding first shift registers 81A, whereas the second latch circuits 82B are electrically connected to corresponding second shift registers 81B. Then, when the latch signal LAT from the controller 60 goes to H level, the first latch circuits 82A latch the most significant bit of the corresponding pixel data SI, and the second latch circuits 82B latch the least significant bit of the corresponding pixel data SI. The pieces of pixel data SI latched by the first latch circuits 82A and the second latch circuits 82B (combinations of the most significant bit and the least significant bit) are respectively inputted to the decoders 83. The decoders 83 each select one of the selection signals q0 through q3 (for example, the selection signal q1) outputted from the control logic unit 84 in accordance with the pixel data SI latched by the first latch circuits 82A and the second latch circuits 82B, and output the selected selection signals as the switch control signals SW. The switches 86 are switched on/off in accordance with the switch control signals, and the waveform sections included in the driving signal COM are selectively applied to the piezoelectric elements 417.

Relationship between Pixel Data and Dots

First, a case where a dot is not to be formed (that is, a case where the pixel data SI is [00]) will be described. In the case where pixel data [00] is latched, the selection signal q0 is outputted as the switch control signal SW. The selection signal q0 is a signal specifying whether the switch 86 is to be turned on or off at a given point in time for a nozzle whose pixel data SI is [00], and is outputted by the control logic unit 84; however, the control logic unit 84 defines the value for each latch signal LAT or pulse of the change signal CH (as predetermined) (note that the same applies to the selection signals q1 through q3). Through this, the switch 86 is turned off in the interval T. As a result, the driving pulse of the common driving signal COM is not applied to the piezoelectric element 417. In this case, no ink droplet is ejected through the nozzle.

Next, a case where a small dot is to be formed (that is, a case where the pixel data SI is [01]) will be described. In the case where pixel data [01] is latched, the selection signal q1 is outputted as the switch control signal SW. Through this, the switch 86 is turned on during the interval T11, and the switch 86 is turned off during the interval T12 and the interval T13. As a result, the driving pulse PS1 of the first waveform section SS11 in the common driving signal COM is applied to the piezoelectric element 417, and an ink droplet having a volume corresponding to a small dot is ejected through the nozzle.

Next, a case where a medium dot is to be formed (that is, a case where the pixel data SI is [10]) will be described. In the case where pixel data [10] is latched, the selection signal q2 is outputted as the switch control signal SW. Through this, the switch 86 is turned on during the interval T11 and the interval T12, and the switch 86 is turned off during the interval T13. As a result, the driving pulse PS1 of the first waveform section SS11 in the common driving signal COM and the driving pulse PS2 of the second waveform section SS12 in the common driving signal COM are applied to the piezoelectric element 417, and an ink droplet having a volume corresponding to a medium dot (that is, a medium ink droplet) is ejected through the nozzle.

Next, a case where a large dot is to be formed (that is, a case where the pixel data SI is [11]) will be described. In the case where pixel data [11] is latched, the selection signal q3 is outputted as the switch control signal SW. Through this, the switch 86 is turned on during the interval T11, the interval T12, and the interval T13. As a result, the driving pulse PS1 of the first waveform section SS11 in the common driving signal COM, the driving pulse PS2 of the second waveform section SS12 in the common driving signal COM, and the driving pulse PS3 of the third waveform section SS13 in the common driving signal COM are applied to the piezoelectric element 417, and an ink droplet having a volume corresponding to a large dot (that is, a large ink droplet) is ejected through the nozzle.

Wiring from Head Control Unit HC to Piezoelectric Elements

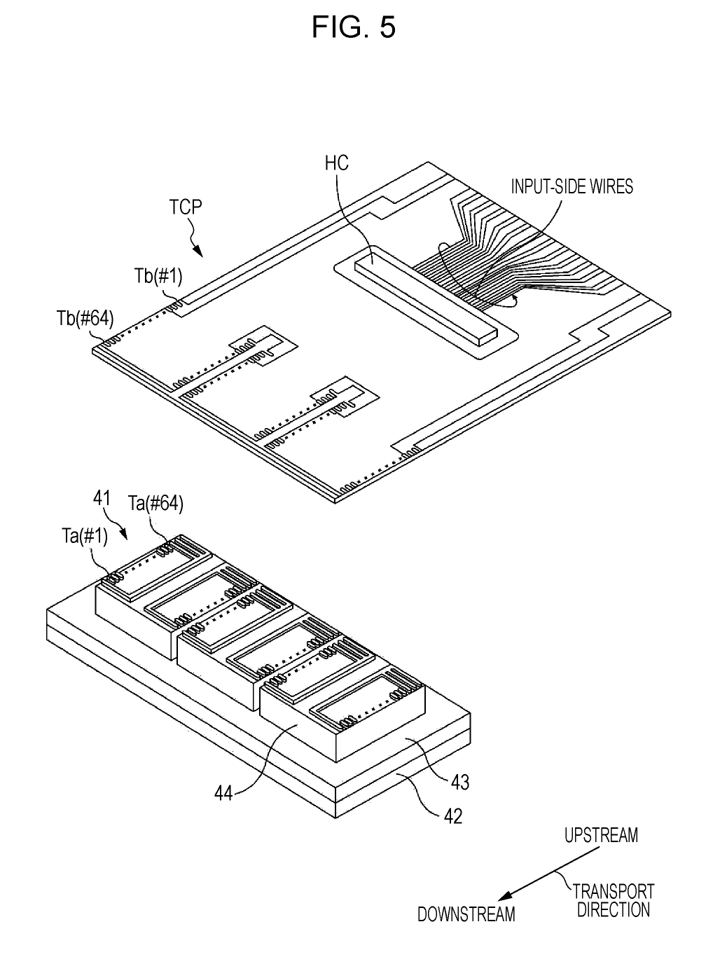

Next, wiring from the head control unit HC to the piezoelectric elements will be described using FIG. 5. FIG. 5 is an exploded perspective view illustrating the periphery of the head control unit HC.

First, the configuration of a head portion according to this embodiment will be described. As shown in FIG. 5, the printer 1 according to this embodiment includes, in the head portion, the head 41 and a tape carrier package (also abbreviated as “TCP” hereinafter).

The head 41 includes a nozzle plate 42, a reservoir plate 43, and an actuator unit 44. Six rows of nozzle openings are formed in the nozzle plate 42. In each row, 64 nozzle openings are formed so as to be arranged in the transport direction. In the following descriptions, each nozzle will be given a number from 1 to 64 in order from the downstream side in the transport direction. A reservoir (holding chamber) that holds ink, and pressure generation chambers for each of the nozzles, are formed in the reservoir plate 43. The piezoelectric elements are provided in the actuator unit 44 in correspondence with the respective nozzles, and the pressure generation chambers in the reservoir plate 43 are caused to expand/contract in accordance with the operations of the piezoelectric elements. Furthermore, connection terminals Ta are provided in the actuator unit 44 for each nozzle (that is, for each piezoelectric element). In other words, 64 connection terminals Ta are provided for a single nozzle row.

The TCP is configured by mounting the head control unit HC, which controls the driving of the head based on input signals from the main unit side (that is, from the controller 60), on a FPC (flexible printed circuit), and the required wiring pattern is formed thereon. Note that the head control unit HC is configured of a semiconductor integrated circuit (IC).

The wiring on the input side of the head control unit HC transmits the aforementioned common driving signal COM, latch signal LAT, change signal CH, pixel data SI, and clock signal CLK and so on.

Furthermore, although not shown in FIG. 5, wiring in the output side of the head control unit HC transmits the application signals to the respective piezoelectric elements.

Note that connection terminals Tb for connecting to the connection terminals Ta in the actuator unit 44 are provided in the TCP for each of the nozzles. In other words, 64 connection terminals Tb are provided for a single nozzle row. Note that the connection terminals Tb are provided so as to correspond to respective connection terminals Ta in the actuator unit 44. The application signals outputted from the head control unit HC pass through the output-side wiring and are applied to the piezoelectric elements via the connection terminals Tb and the connection terminals Ta.

### Head Case 45

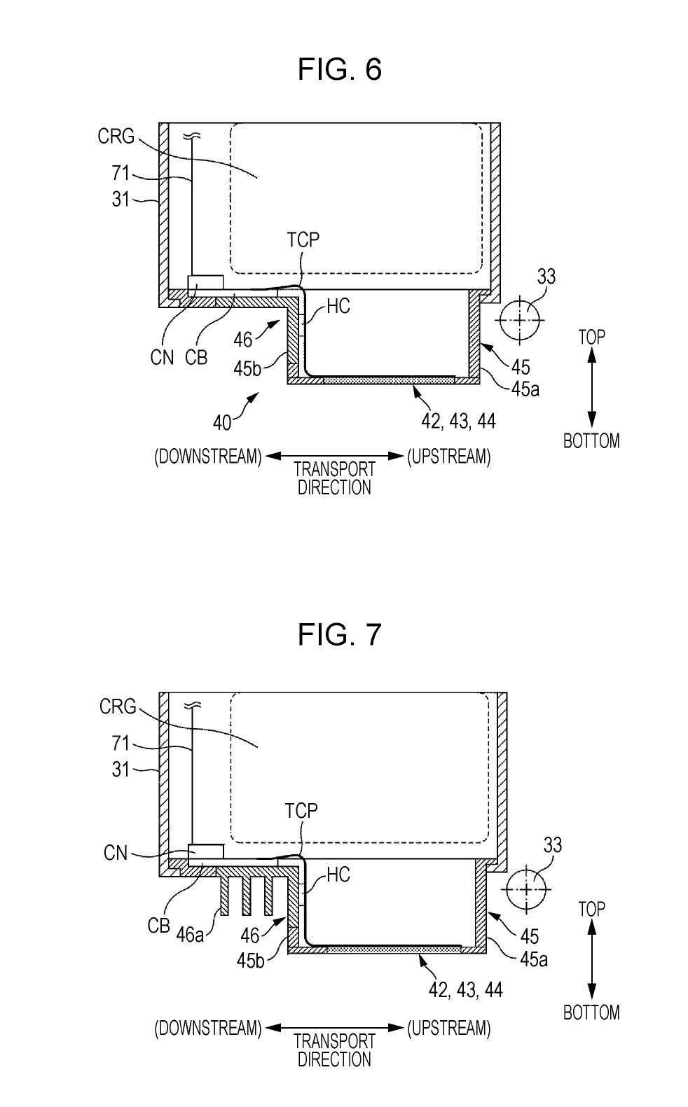

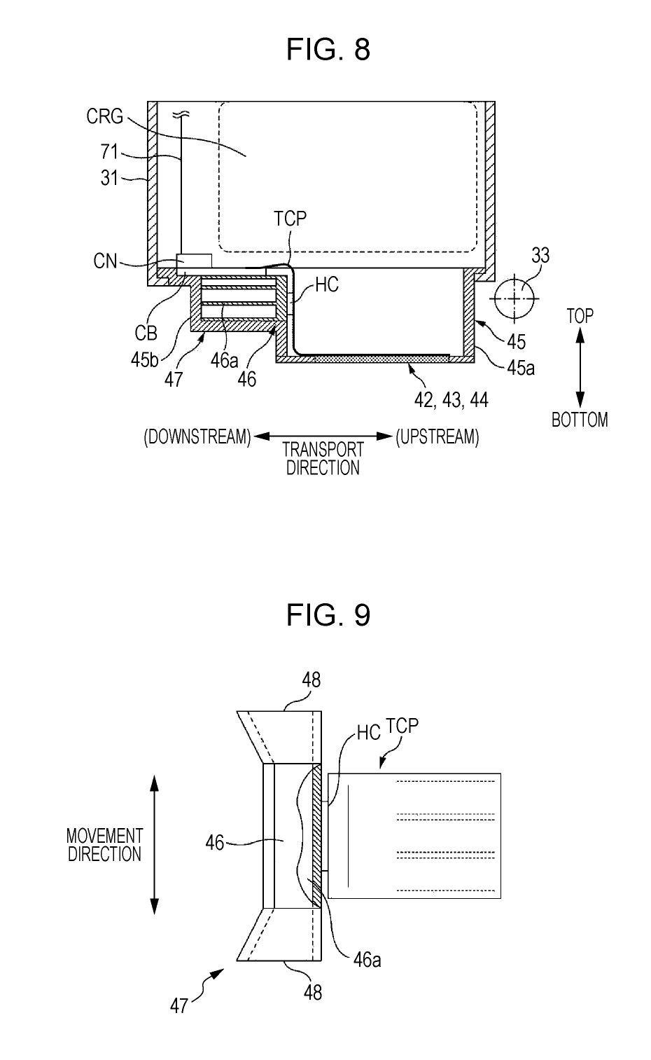

Here, the head case 45 will be described using FIGS. 6 through 9. FIG. 6 is a general diagram illustrating the head unit 40 in a state in which the head unit 40 is attached to the carriage 31, and the configuration of the head case 45 is illustrated using a cross-section seen from the side. FIG. 7 is a diagram illustrating a different example of the configuration of the head case 45. FIG. 8 is a diagram illustrating a different example of the configuration of the head case 45. FIG. 9 is a plan view illustrating the configuration of an air cavity portion 47. Note that in FIG. 9, of the elements in the head unit 40, only the air cavity portion 47 and the TCP (the head control unit HC) are picked and illustrated.

### Heat Produced by Head Control Unit HC

As described above, ink droplets of a predetermined size are ejected through the nozzles toward the medium S by the head control unit HC controlling the switches 86 to turn on/off based on the print data and selectively applying the necessary waveform sections of the common driving signal COM to the piezoelectric elements 417. The printer 1 according to this embodiment carries out printing by repeating the ejection of such ink droplets.

However, if printing is carried out over a long span of time, the on/off control, which determines whether or not driving signals will be applied to the driving elements, is frequently repeated by the switches 86. Such being the case, an excessive amount of heat will be produced by the transistors of which the switches 86 are configured, and as a result, the temperature within the head control unit HC will rise greatly. Ejection problems and so on will result, which will cause malfunctions in the printer 1.

In response to this, with the head unit 40 according to this embodiment, part of the head case 45 is formed of a metal member, and the head control unit HC is housed within the case in a state in which the head control unit HC makes contact with this metal member. Accordingly, the heat produced by the head control unit HC can be effectively dissipated.

Hereinafter, examples of the configuration of this head case 45 will be described in detail according to a first working example, a second working example, and a third working example.

### FIRST WORKING EXAMPLE

First, the head case 45 according to the first working example will be described using FIG. 6.

Note that an ink introduction pin, an ink flow channel, and so on to which the ink cartridge CRG is mounted are not depicted in the head unit 40 shown in FIG. 6. Furthermore, although the head case 45 in FIG. 6 is illustrated as having its top surface open, it is assumed that this top surface is sealed.

The head case 45 is a casing that is supported by the carriage 31 and that is configured so as to be capable of housing the head 41 and the head control unit HC.

The head case 45 is formed primarily of a synthetic resin, but has a section 46 that is formed of a metal member (this will be called a “metal section 46” hereinafter). In other words, the head case 45 is formed so that a synthetic resin and the metal member are integrated. Furthermore, the head case 45 has the nozzle plate 42 on its bottom surface.

The reservoir plate 43 is affixed to the upper surface of the nozzle plate 42 using an adhesive film.

A supply plate (not shown) that supplies ink to the reservoir plate 43 is affixed to the upper surface of the reservoir plate 43 using an adhesive film.

The actuator unit 44 is affixed to the upper surface of the supply plate using an adhesive film.

The TCP that includes the head control unit HC is affixed to the upper surface of the actuator unit 44. By affixing the TCP in this manner, the connection terminals Tb thereof are connected in correspondence with the respective connection terminals Ta of the actuator unit 44 (see FIG. 5).

The TCP is formed using a flexible member, and is thus capable of bending freely. In this embodiment, as shown in FIG. 6, the TCP is bent upward along the inner wall of the head case 45, thus putting the head control unit HC in contact with the metal section 46. The head control unit HC is affixed to the metal section 46 using an adhesive configured of a material that has a high thermal conductivity.

In this manner, part of the head case 45 is formed from the metal section 46, and the head control unit HC is housed within the case in a state in which the head control unit HC is in contact with the metal section 46, and thus the heat produced by the head control unit HC dissipates into the air from the surface of the metal section 46.

Furthermore, as shown in FIG. 6, the TCP is bent toward the downstream side of the transport direction, and the end of the TCP that is on the opposite side of the end that faces the actuator unit 44 is anchored to a circuit board CB. A connector CN is mounted on the circuit board CB. The TCP is electrically connected to the connector CN via the circuit board CB. The flexible cable 71 is connected to the connector CN.

Accordingly, when the common driving signal COM generated by the driving signal generation unit 65 is transmitted from the main unit side (that is, from the controller 60) to the head unit 40, the common driving signal COM travels through the flexible cable 71, the connector CN, the circuit board CB, and the TCP in that sequence, and is received by the actuator unit 44.

Meanwhile, as shown in FIG. 6, the head case 45 includes a first side surface portion 45a downstream from the guide rail 33 in the transport direction and a second side surface portion 45b downstream from the first side surface portion 45a in the transport direction.

In this embodiment, the metal section 46 is provided on the side of the head case 45 where the second side surface portion 45b is located. Because the second side surface portion 45b side is closer than the first side surface portion 45a side to a discharge port from which the medium S is discharged, providing the metal section 46 on the side where the second side surface portion 45b is located makes it easier for the metal section 46 to come into contact with the air outside of the printer that is cooler than the air inside of the printer. Accordingly, the heat dissipation effects can be further improved.

Furthermore, as shown in FIG. 6, the head case 45 is supported so as to protrude downward from an opening provided in the bottom surface of the carriage 31, and the metal section 46 is exposed from that opening. Through this, the heat produced by the head control unit HC can be dissipated from the front surface of the metal section 46 that makes contact with the external air, and thus heat can be suppressed from being trapped within the head case 45. In addition, because the metal section 46 makes contact with air as the carriage 31 moves along the guide rail 33 in the movement direction, the dissipation of heat from the head control unit HC can be facilitated.

Furthermore, the head case 45 is configured so that the metal section 46 is at a ground potential. In this manner, by grounding the metal section 46, static electricity that has built up in the head control unit HC and the like can be discharged, which makes it possible to suppress the head control unit from being damaged by static electricity, suppress erroneous operations caused by the static electricity overlapping with the driving signals as noise, and so on.

### SECOND WORKING EXAMPLE

Next, the head case 45 according to the second working example will be described using FIG. 7.

Note that, as in FIG. 6, an ink introduction pin, an ink flow channel, and so on to which the ink cartridge CRG is mounted are not depicted in the head unit 40 shown in FIG. 7. Furthermore, although the head case 45 in FIG. 7 is illustrated as having its top surface open, it is assumed that this top surface is sealed.

With the head case 45 according to the second working example, the configuration of the metal section 46 is different from that in the head case 45 according to the first working example. Accordingly, the metal section 46 that has a different configuration from that in the first working example will be described.

The head case 45 according to the second working example has, as shown in FIG. 7, a plurality of rectangular fins 46a in the metal section 46.

The plurality of fins 46a, which protrude downward, are formed as an integral part of the metal section 46, and the plurality of fins 46a are arranged so as to be parallel to each other along the transport direction.

By providing the plurality of fins 46a in the metal section 46 in this manner, the surface area of the metal section 46 can be increased; this makes it possible to increase the amount of heat that is dissipated, which in turn improves the heat dissipation effects even more.

### THIRD WORKING EXAMPLE

Next, the head case 45 according to the third working example will be described using FIGS. 8 and 9.

Note that, as in FIG. 6, an ink introduction pin, an ink flow channel, and so on to which the ink cartridge CRG is mounted are not depicted in the head unit 40 shown in FIG. 8. Furthermore, although the head case 45 in FIG. 8 is illustrated as having its top surface open, it is assumed that this top surface is sealed.

With the head case 45 according to the third working example, the configuration of the metal section 46 is different from that in the head case 45 according to the first working example. Accordingly, the metal section 46 that has a different configuration from that in the first working example will be described.

The head case 45 according to the third working example has, as shown in FIG. 8, a plurality of rectangular fins 46a in the metal section 46.

The plurality of fins 46a, which protrude toward the downstream side in the transport direction, are formed as an integral part of the metal section 46, and the plurality of fins 46a are arranged so as to be parallel to each other along the vertical direction.

As shown in FIG. 8, the metal section 46 is anchored to the head case 45 in a state in which the respective leading end portions of the plurality of fins 46a make contact with the second side surface portion 45b of the head case 45. Accordingly, the air cavity portion 47 is formed by the metal section 46 and the head case 45.

The air cavity portion 47 is, as shown in FIG. 9, provided following the movement direction, and includes ventilation ports 48 and 48 on both sides thereof.

Accordingly, when the carriage 31 moves in the movement direction, air flows into the air cavity portion 47 through the ventilation ports 48, which serve as exit/entry ports.

The air that has flowed into the air cavity portion 47 makes contact with the surfaces of the plurality of fins 46a, and thus the metal section 46 is cooled by the air.

As a result, the heat produced by the head control unit HC is dispersed into the air from the surface of the metal section 46, and thus heat can be suppressed from being trapped within the head case 45.

Meanwhile, as shown in FIG. 9, both ends of the air cavity portion 47 have tapered shapes. Accordingly, the cross-sectional size of the air cavity portion 47 (a cross-section viewed from the movement direction) gradually decreases toward the middle of the air cavity portion 47 (that is, the flow channel gradually narrows), and then gradually increases (that is, the flow channel gradually widens) after passing the middle section of the air cavity portion 47 (that is, the portion in which the fins 46a are formed).

As shown in FIG. 9, the ventilation ports 48 are formed so as to have a larger size than the cross-sectional size of the air cavity portion 47 that is between the ventilation ports.

Accordingly, the air that has flowed into the air cavity portion 47 from the ventilation port 48 on one side due to the movement of the carriage 31 advances into the air cavity portion at a higher rate of speed due to the cross-sectional shape of the air cavity portion 47 decreasing, and then flows out from the ventilation port 48 on the other side at a lower rate of speed due to the cross-sectional shape of the air cavity portion 47 increasing.

By increasing the size of the ventilation ports 48 in this manner, the amount of air that is conducted into the air cavity portion 47 can be increased, which makes it possible for the air that has been conducted into the air cavity portion 47 to pass through without stagnating; as a result, the metal section 46 is cooled more efficiently.

As a result, the heat produced by the head control unit HC can be efficiently dispersed from the surface of the metal section 46, which makes it possible to suppress the occurrence of erroneous operations in the head control unit HC.

### Other Embodiments

Although the aforementioned embodiment has primarily described a liquid ejecting apparatus, a liquid ejecting method and so on also falls within the scope of this disclosure. Furthermore, the aforementioned embodiment is provided to facilitate understanding of the invention and is not to be interpreted as limiting the invention in any way. It goes without saying that many variations and modifications can be made without departing from the essential spirit of the invention, and thus all such variations and modifications also fall within the scope of the invention. In particular, the embodiments described hereinafter also fall within the scope of the invention.

### Liquid Ejecting Apparatus

Although the aforementioned embodiment describes an ink jet printer as an example of a liquid ejecting apparatus, the invention is not limited thereto. For example, the invention may be applied in a liquid ejecting apparatus that ejects a liquid aside from ink. The invention can also be applied in various types of liquid ejecting apparatuses including liquid ejecting heads or the like that eject minute liquid droplets. Note that “droplet” (ink droplet) refers to the state of the liquid ejected from the liquid ejecting apparatus, and is intended to include granule forms, teardrop forms, and forms that pull tails in a string-like form therebehind. Furthermore, the “liquid” referred to here can be any material capable of being ejected by the liquid ejecting apparatus. For example, any matter can be used as long as the matter is in its liquid state, including liquids having high or low viscosity, sol, gel water, other inorganic agents, organic agents, liquid solutions, liquid resins, and fluid states such as liquid metals (metallic melts); furthermore, in addition to liquids as a single state of a matter, liquids in which the molecules of a functional material composed of a solid matter such as pigments, metal particles, or the like are dissolved, dispersed, or mixed in a liquid carrier are included as well. Ink, described in the above embodiment as a representative example of a liquid, liquid crystals, or the like can also be given as examples. Here, “ink” generally includes water-based and oil-based inks, as well as various types of liquid compositions, including gel inks, hot-melt inks, and so on. The following are specific examples of liquid ejecting apparatuses: liquid ejecting apparatuses that eject liquids including materials such as electrode materials, coloring materials, and so on in a dispersed or dissolved state for use in the manufacture and so on of, for example, liquid-crystal displays, EL (electroluminescence) displays, surface emission displays, and color filters; liquid ejecting apparatuses that eject bioorganic matters used in the manufacture of biochips; liquid ejecting apparatuses that eject liquids to be used as samples for precision pipettes; printing equipment and microdispensers; and so on. Furthermore, the invention may be employed in liquid ejecting apparatuses that perform pinpoint ejection of lubrication oils into the precision mechanisms of clocks, cameras, and the like; liquid ejecting apparatuses that eject transparent resin liquids such as ultraviolet light-curable resins onto a substrate in order to form miniature hemispheric lenses (optical lenses) for use in optical communication elements; and liquid ejecting apparatuses that eject an etching liquid such as an acid or alkali onto a substrate or the like for etching. The invention can be applied to any type of these liquid ejecting apparatuses.

### Others

Although the aforementioned embodiment describes a TCP, the invention is not limited to a TCP. For example, a COF (chip on film) may be employed instead.

Furthermore, although the aforementioned embodiment describes a single head control unit HC controlling six nozzle rows, the invention is not limited thereto. The invention can also be applied in the case where a single head control unit HC controls only a single nozzle row.

Furthermore, although the aforementioned embodiment describes a case in which the switches 86 within the head control unit HC produces heat, the invention is not limited to such a case, and the invention can also be applied in the case where other elements in the head control unit HC aside from the switches 86 function as sources of heat.

What is claimed is:

1. A liquid ejecting apparatus comprising:
a carriage that moves in an orthogonal direction that is orthogonal to a transport direction in which a medium is transported; and
a head unit, provided in the carriage, that includes a nozzle, a driving element that causes a liquid to be ejected through the nozzle, a head control unit that controls the driving of the driving element by selectively applying a driving signal to the driving element, and a head case that has a part formed of a metal member and that houses the head control unit within the case in a state in which the head control unit makes contact with the metal member.

2. The liquid ejecting apparatus according to claim 1,
wherein the part formed of the metal member is grounded.

3. The liquid ejecting apparatus according to claim 1,
wherein the carriage moves in the orthogonal direction along a guide rail;
the head case has a first side surface portion that is downstream from the guide rail in the transport direction and a second side surface portion that is downstream from the first side surface portion in the transport direction; and
the part formed of the metal member is provided on an area of the head case that is toward the second side surface portion.

4. The liquid ejecting apparatus according to claim 1,
wherein the carriage has an opening in its bottom surface;
the head case is supported by the carriage in a state in which the part formed of the metal member is exposed from the opening; and
the part formed of the metal member is cooled as a result of the carriage moving in the orthogonal direction.

5. The liquid ejecting apparatus according to claim 1,
wherein the part formed of the metal member has a plurality of fins.

6. The liquid ejecting apparatus according to claim 1,
wherein the part formed of the metal member forms an air cavity portion that follows the orthogonal direction;
the air cavity portion has a ventilation port on one side and the other side in the orthogonal direction; and
the ventilation ports are formed so that the sizes of the ventilation ports are greater than the cross-sectional size of the air cavity portion that is located between the ventilation ports.
